(19) United States
(12) Patent Application Publication
(10) Pub. No.: US 2021/0097669 A1
(43) Pub. Date: Apr. 1, 2021

(54) RECOVERY OF DROPOUTS IN SURFACE MAPS

(71) Applicants: OREGON STATE UNIVERSITY, Corvallis, OR (US); HEWLETT-PACKARD DEVELOPMENT COMPANY, L.P., Spring, TX (US)

(72) Inventors: Daniel Mosher, Corvallis, OR (US); Brian Bay, Corvallis, OR (US); David A. Champion, Corvallis, OR (US)

(21) Appl. No.: 16/608,369

(22) PCT Filed: Mar. 23, 2018
(86) PCT No.: PCT/US2018/024186

§ 371 Date: Oct. 25, 2019

(51) Int. Cl. G06T 7/00; G06T 7/174; G06T 7/11; G06K 9/46; G06K 9/62; G06T 7/593; B29C 64/386; B33Y 50/00

(52) U.S. Cl. CPC G06T 7/0004; G06T 7/174; G06T 7/11; G06K 9/4671; G06T 2207/30144; G06T 7/593; B29C 64/386; B33Y 50/00; G06T 2207/10012; G06K 9/6232

(57) ABSTRACT

According to examples, an apparatus may include a processor and a memory on which are stored machine readable instructions that when executed by the processor, cause the processor to determine whether a first surface map includes a dropout, the first surface map being generated using a first image parameter on a first image and a second image. The instructions may also cause the processor to, based on a determination that the first surface map includes a dropout, recover information corresponding to the dropout. The instructions may further cause the processor to generate a recovered surface map using the recovered information and store the recovered surface map.

### BACKGROUND

In three-dimensional (3D) printing, an additive printing process may be used to make three-dimensional solid parts from a digital model. Some 3D printing techniques are considered additive processes because they involve the application of successive layers or volumes of a build material, such as a powder or powder-like build material, to an existing surface (or previous layer). 3D printing often includes solidification of the build material, which for some materials may be accomplished through use of heat and/or a chemical binder.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that may provide for recovery of surface measurement dropouts in surface maps;

FIG. 2 shows a diagram of an example 3D fabrication system in which the apparatus depicted in FIG. 1 may be implemented;

FIGS. 3A-3C, collectively, show an example process in which surface information at a dropout location may be recovered;

FIGS. 4 and 5, respectively, show flow diagrams of example methods for recovering a surface measurement dropout; and

FIG. 6 shows a block diagram of a non-transitory computer readable medium on which is stored machine readable instructions for recovering dropouts in a 3D surface map.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are apparatuses, methods, and computer readable mediums for recovering dropouts in surface maps. Particularly, for instance, a processor as disclosed herein may determine whether a first surface map, which may be a 3D surface map, a stereoscopic 3D map, or the like, includes a dropout. The first surface map may be generated by combining a first image and a second image of a surface of a layer of build material particles. For instance, the first image and the second image may be combined via a pixel-wise comparison of trackable features in the first image and trackable features in the second image. In some instances, a sufficient correlation may not exist between some of the trackable features in the first image and some of the trackable features in the second image. As a result, surface information corresponding to those trackable features may not be identified and thus locations on the surface map corresponding to those trackable features may not be displayed with the surface information. Instead, those locations may be displayed as dark or gray areas on the surface map. In addition, the dark or gray areas on a surface map for which surface information may be missing may be termed “dropouts.”

A dropout may represent a pointwise surface measurement that is removed from consideration in the surface map because the dropout does not meet a predetermined accuracy criteria. In other words, the dropout location may not provide sufficient image data for a surface measurement to be displayed on the surface map. Dropouts may result from misaligned or missing surface measurement parameters. That is, in order to produce surface measurement data for a sample location, a surface measurement component may access two images of the layer captured from different angles and may extract subsets (e.g., sections) of a certain size (and/or other parameter) from both images. The subsets may correspond to the same sample location. In addition, the image data from the sections may be compared in order to determine if a correlation exists, e.g., whether the sections have sufficiently similar image data. If a correlation does not exist, sufficient information may not be identified and a dropout may be displayed on the surface map.

In examples, the location of the dropout may be identified so that the dropout, e.g., the missing surface information, may be recovered. As disclosed herein, a processor may apply various image parameters to the images used to generate the surface map to recover the dropout. That is, through application of the image parameters on the sections of the images corresponding to the location of the dropout, recovered regions on the images may be identified. The recovered regions may include different or differently displayed features as compared with the sections used to generate the surface map, which may result in a greater correlation at the location of the dropout and which may enable recovery of the dropout. In addition, the processor may apply the various image parameter on the locations at which dropouts have been identified instead on the entire areas of the images used to generate the surface map. In this regard, the processor may limit or reduce the time and processing resources used to recover dropouts in surface maps.

Through implementation of the apparatuses, methods, and computer readable mediums disclosed herein, a recovered surface map may be generated, in which the recovered surface map may recover measurement dropouts appearing on a surface map. In addition, the measurement dropouts may be recovered in a relatively efficient manner while consuming a reduced amount of processing or computing resources by, for instance, limiting recovery operations to areas of the surface map at which the measurement dropouts appear instead of applying recovery operations across the images from which the surface map is generated.

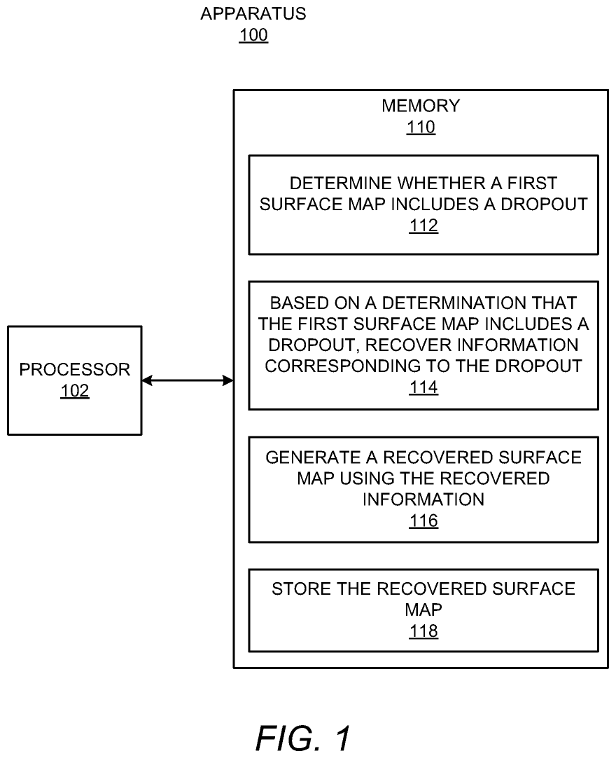

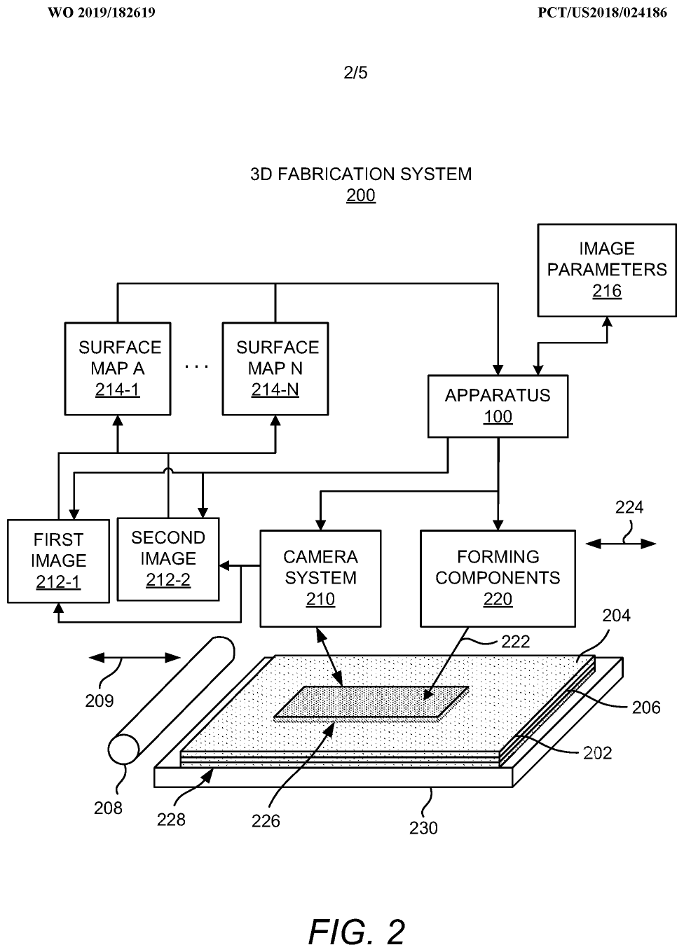

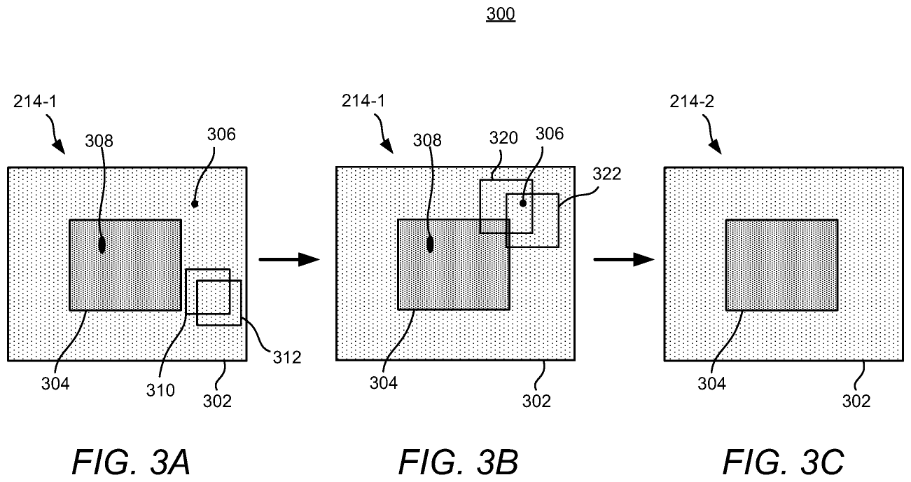

Reference is made to FIGS. 1, 2, and 3A-3C. FIG. 1 shows a block diagram of an example apparatus 100 that may provide for surface map dropout recovery. FIG. 2 shows a diagram of an example 3D fabrication system 200 in which the apparatus 100 depicted in FIG. 1 may be implemented. FIGS. 3A-3C, collectively, show an example process in which surface information at a dropout location may be recovered. It should be understood that the example apparatus 100 depicted in FIG. 1, the example 3D fabrication system 200 depicted in FIG. 2, and the example process 300 may include additional features and that some of the features described herein may be removed and/or modified without departing from the scopes of the apparatus 100, the 3D fabrication system 200, or the process 300.

The apparatus 100 may be a computing device, a tablet computer, a server computer, a smartphone, or the like. The apparatus 100 may also be part of a 3D fabrication system 200, e.g., a control system of the 3D fabrication system 200. Although a single processor 102 is depicted, it should be understood that the apparatus 100 may include multiple processors, multiple cores, or the like, without departing from a scope of the apparatus 100.

The 3D fabrication system 200, which may also be termed a 3D printing system, a 3D fabricator, or the like, may be implemented to fabricate 3D objects through selectively solidifying of build material particles 202, which may also be termed particles 202 of build material, together. In some examples, the 3D fabrication system 200 may use energy, e.g., in the form of light and/or heat, to selectively fuse the particles 202. In addition or in other examples, the 3D fabrication system 200 may use binding agents to selectively bind or solidify the particles 202. In particular examples, the 3D fabrication system 200 may use fusing agents that increase the absorption of energy to selectively fuse the particles 202.

According to one example, a suitable fusing agent may be an ink-type formulation including carbon black, such as, for example, the fusing agent formulation commercially known as V1Q60Q “HP fusing agent” available from HP Inc. In one example, such a fusing agent may additionally include an infra-red light absorber. In one example such fusing agent may additionally include a near infra-red light absorber. In one example, such a fusing agent may additionally include a visible light absorber. In one example, such a fusing agent may additionally include a UV light absorber. Examples of fusing agents including visible light enhancers are dye based colored ink and pigment based colored ink, such as inks commercially known as CE039A and CE042A available from HP Inc. According to one example, the 3D fabrication system 200 may additionally use a detailing agent. According to one example, a suitable detailing agent may be a formulation commercially known as V1Q61A “HP detailing agent” available from HP Inc.

The build material particles 202 may include any suitable material for use in forming 3D objects. The build material particles 202 may include, for instance, a polymer, a plastic, a ceramic, a nylon, a metal, combinations thereof, or the like, and may be in the form of a powder or a powder-like material. Additionally, the build material particles 202 may be formed to have dimensions, e.g., widths, diameters, or the like, that are generally between about 5 μm and about 100 μm. In other examples, the particles may have dimensions that are generally between about 30 μm and about 60 μm. The particles may have any of multiple shapes, for instance, as a result of larger particles being ground into smaller particles. In some examples, the particles may be formed from, or may include, short fibers that may, for example, have been cut into short lengths from long strands or threads of material. In addition or in other examples, the particles may be partially transparent or opaque. According to one example, a suitable build material may be PA12 build material commercially known as V1R10A “HP PA12” available from HP Inc.

As shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device. The apparatus 100 may also include a memory 110 that may have stored thereon machine readable instructions 112-118 (which may also be termed computer readable instructions) that the processor 102 may execute. The memory 110 may be an electronic, magnetic, optical, or other physical storage device that contains or stores executable instructions. The memory 110 may be, for example, Random Access memory (RAM), an Electrically Erasable Programmable Read-Only Memory (EEPROM), a storage device, an optical disc, and the like. The memory 110, which may also be referred to as a computer readable storage medium, may be a non-transitory machine-readable storage medium, where the term “non-transitory” does not encompass transitory propagating signals.

The 3D fabrication system 200 may include a spreader 208 that may spread the build material particles 202 into a layer 206, e.g., through movement across a platform 230 as indicated by the arrow 209. A first surface map 214-1, which may also be referenced as a first 3D surface map or a stereoscopic 3D image, may be created from two offset images, e.g., a first image 212-1 and a second image 212-2, of the layer surface 204 to give the perception of 3D depth. For instance, the first surface map 214-1 may display height (z-direction) information of the build material particles 202 in the layer 206.

As shown in FIG. 2, the 3D fabrication system 200 may include a camera system 210 to capture the offset images 212-1, 212-2. The camera system 210 may include a single camera or multiple cameras positioned at different angles with respect to each other such that multiple ones of the captured images 212-1, 212-2 may be combined to generate a surface map 214-1. According to examples, the camera system 210 may capture high-resolution images, e.g., high definition quality, 4K resolution quality, or the like, such that the stereoscopic 3D images generated from images captured by the camera system 210 may also be of high resolution. In addition, the 3D fabrication system 200 may include a light source (not shown) to illuminate the layer surface 204 and enable the camera system 210 to capture fine details in the layer surface 204.

The processor 102 may control the camera system 210 to capture multiple images 212-1 and 212-2 of the layer surface 204 and the first surface map 214-1 may be generated from the multiple captured images 212-1 to 212-2. For instance, the camera system 210 may have been controlled to capture the first image 212-1 of the layer surface 204 from a first angle with respect to the layer surface 204 and may have been controlled to capture the second image 212-2 of the layer surface 204 from a second, offset angle with respect to the layer surface 204. In addition, the first image 212-1 may have been combined with the second image 212-2 to create the first surface map 214-1. In some examples, a first camera of the camera system 210 may have captured the first image 212-1 and a second camera of the camera system 210 may have captured the second image 212-2. In other examples, a single camera of the camera system 210 may have captured the first image 212-1 and may have been moved or otherwise manipulated, e.g., through use of mirrors and/or lenses, to capture the second image 212-2.

The camera system 210 may generate the first surface map 214-1 from the multiple captured images 212-1 and 212-2 and may communicate the generated first surface map 214-1 to the processor 102 or to a data store from which the processor 102 may access the first surface map 214-1 of the layer surface 204. In other examples, the camera system 210 may store the captured images in a data store (not shown) and the processor 102 may generate the first surface map 214-1 of the layer surface 204 from the stored images.

As also shown in FIG. 2, the 3D fabrication system 200 may include forming components 220 that may output energy/agent 222 onto the layer 206 as the forming components 220 are scanned across the layer 206 as denoted by the arrow 224. The forming components 220 may also be scanned in the direction perpendicular to the arrow 224 or in other directions. In addition, or alternatively, a platform 230 on which the layers 206 are deposited may be scanned in directions with respect to the forming components 220.

The fabrication system 200 may include a build zone 228 within which the forming components 220 may solidify the build material particles 202 in a selected area 226 of the layer 206. The selected area 226 of a layer 206 may correspond to a section of a 3D object being fabricated in multiple layers 206 of the build material particles 202. The forming components 220 may include, for instance, an energy source, e.g., a laser beam source, a heating lamp, or the like, that may apply energy onto the layer 206 and/or that may apply energy onto the selected area 226. In addition or alternatively, the forming components 220 may include a fusing agent delivery device to selectively deliver a fusing agent onto the build material particles 202 in the selected area 226, in which the fusing agent enhances absorption of the energy to cause the build material particles 202 upon which the fusing agent has been deposited to melt. The fusing agent may be applied to the build material particles 202 prior to application of energy onto the build material particles 202. In other examples, the forming components 220 may include a binding agent delivery device that may deposit a binding agent, such as an adhesive that may bind build material particles 202 upon which the binding agent is deposited.

The solidified build material particles 202 may equivalently be termed fused build material particles, bound build material particles, or the like. In any regard, the solidified build material particles 202 may be a part of a 3D object, and the 3D object may be built through selective solidifying of the build material particles 202 in multiple layers 206 of the build material particles 202.

In some examples, the captured images 212-1, 212-2 used to create the first surface map 214-1 of the layer 206 may have been captured prior to a solidifying operation being performed on the layer 206 of build material particles 202. In other examples, the captured images 212-1, 212-2 used to create the first surface map 214-1 may have been captured following a solidifying operation being performed on the layer 206. In these examples, the first surface map 214-1 may have been created from images 212 that include both build material particles 202 in the selected area 226 of the layer 206 that have been solidified together and build material particles 202 that have not been solidified together. In still other examples, the camera system 210 may continuously capture images, e.g., video, and the continuously captured images may be used to continuously create multiple stereoscopic 3D images, e.g., video.

An example of a first surface map 214-1 and a recovered surface map 214-2 are depicted in FIGS. 3A-3C. It should be understood that FIGS. 3A-3C merely depict an example process and should thus not be construed as limiting the present disclosure to the features depicted in those figures. As shown in FIG. 3A, the first surface map 214-1 may include a first area 302, which may correspond to build material particles 202 that have not been solidified together. In addition, the first surface map 214-1 may include a second area 304, which may correspond to an area of solidified build material particles 202. The different shadings in the first surface map 214-1 may denote different features of the layer 206, such as various heights of the build material particles 202 in the layer 206, various colors of the build material particles 202 on the layer 206, various other properties of the build material particles 202 on the layer 206, or the like. It should be understood that the first surface map 214-1 has been depicted as having two types of shadings for purposes of illustration and that the first surface map 214-1 may instead depict a large number of different colors or optical properties.

The first image 212-1 and the second image 212-2 may be combined to generate the first surface map 214-1. According to examples, sections 310 in the first image 212-1 may be combined with corresponding sections 312 in the second image 212-2 to generate the first surface map 214-1. As shown in FIG. 3A, the sections 310, 312 may correspond to areas of the first image 212-1 and the second image 212-2 that are relatively smaller than the entire first image 212-1 or the entire second image 212-2. Various parameters of the sections 310, 312 may affect the detail captured in the sections 310, 312 and the processing time for generating the first surface map 214-1. The parameters may include sizes of the sections, spacings between subsets of the sections 310, 312 in the first image 212-1 and the second image 212-1, a spacing between control points where recovery is to be performed within a region of the first image 212-1 and/or second image 212-2 at which the dropout may be located, orientations of the sections 310, 312, shapes of the sections 310, 312, densities of the sections 310, 312, etc. For instance, large section 310, 312 sizes may reduce the occurrence of dropouts while small section 310, 312 sizes may improve detail of the first surface map 214-1. In addition, a closer spacing between the sections 310, 312 may both reduce the occurrence of dropouts and may improve detail, but may lead to a significant increase in processing time and processing resource consumption.

According to examples, the spacing between the first section 310 and the second section 312 may be the stereoscopic disparity between the first section 310 and the second section 312. As a result, an “image section” search process within the parameter update may be implemented in which the search process may include finding, for instance, the corresponding location of the first section 310 in the second image 312 or vice-versa.

According to examples, sections 310 of the first image 212-1 may be mapped to sections 312 of the second image 212-2 through tracking of features in the first image 212-1 and the second image 212-2. The features may include, for instance, various textures (e.g., surfaces of either or both of solidified and unsolidified build material particles 202) appearing in the sections 310, 312 of both the first image 212-1 and the second image 212-2. However, surface measurement dropouts 306, 308 may occur in the first surface map 214-1 due to local changes in the scale, quality, orientation, anisotropy, or the like, of the tracked features on the first image 212-1 and/or the second image 212-2. That is, due to the local changes, there may be insufficient correlation between some of the features in the first image 212-1 and some of the features in the second image 212-2. When there is insufficient correlation between the features, some surface information, e.g., the height (z-direction), of the build material particles 202 at the locations of the features may not be determined from the combined images 212-1, 212-2. As a result, the processor 202 may display those locations as dark or gray areas, e.g., dropouts 306, 308.

A correlation between corresponding features in the first image 212-1 and the second image 212-2 may exist, for instance, if a certain degree of matching of image data is achieved in a pixel-wise comparison between the features in the sections in the images 212-1 and 212-2. An exact match may not be achieved, but an approximate match based on a pre-set matching threshold value may indicate that a sufficient correlation exists between the locations in the images 212-1 and 212-2 or that a sufficient correlation is lacking. In instances in which an approximate match between the images 212-1 and 212-2, e.g., a pixel-by-pixel match, fails to meet the pre-set matching threshold value for a sample location, the processor 102 may determine that the first surface map 214-1 includes a surface measurement dropout 306. In these instances, the processor 102 may display the dropout 306 in the first surface map 214-1, e.g., as a dark or grey area that does not convey surface information at that area. However, in instances in which the processor 102 determines that there is an approximate match between the images 212-1 and 212-2, the processor 102 may determine that the first surface map 214-1 does not include a dropout. In these instances, the processor 102 may display the first surface map 214-1 without a dropout 306 and the first surface map 214-1 may display surface information for the layer 206. As also shown in FIG. 3A, the first surface map 214-1 may include a second dropout 308 and/or additional dropouts (not shown).

The processor 102 may fetch, decode, and execute the machine-readable instructions 112 to determine whether a first surface map 214-1 includes a dropout 306. Particularly, for instance, the processor 102 may analyze the first surface map 214-1, of a layer 206 of build material particles 202, to determine whether any dropouts 306, 308 are present in the first surface map 214-1. That is, the processor 102 may determine that the first surface map 214-1 includes a dropout 306 based on a determination that there is missing surface information. The processor 102 may also determine the location on the first surface map 214-1 at which the dropout 306 is displayed. The dropout 306 may also be referenced herein as a surface measurement dropout 306.

The processor 102 may fetch, decode, and execute the machine-readable instructions 114 to, based on a determination that the first surface map 214-1 includes a dropout 306, recover information corresponding to the dropout 306. For instance, the processor 102 may recover the missing information corresponding to the dropout 306 by applying one image parameter 216 or a plurality of image parameters 216 to a first section of the first image 212-1 and to a second section of the second image 212-2 to identify recovered regions 320, 322 in the first image 212-1 and the second image 212-2 (see FIG. 3B). By applying an image parameter 216 or multiple image parameters 216 that differ from the image parameter used to generate the first surface map 214-1, the level of detail of the features in the recovered regions 320, 322 may be increased or decreased, which may result in the missing information corresponding to the dropout 306 being recovered when the recovered regions 320, 322 are combined. The image parameter 216 may include, for instance, a size, a shape, an orientation, a control point spacing, an anisotropy, or the like, that may differ from the image parameter used for the first image 212-1 and the second image 212-2 in generating the first surface map 214-1.

For example, a size image parameter may be used to measure pointwise stereoscopic disparity (surface height variation). A weighting profile of sections in the first and second images 212-1, 212-2, e.g., pixels around the center of the sections, may be weighted higher than the peripheral ones (i.e., center-weighted sections). For instance, center-weighted sections may be changed to uniform-weighted sections to achieve correlation between the sections. The shape parameter may include various shapes, such as a square shape, a rectangular shape, a triangular shape, etc. The orientation parameter may include various rotational angles of the sections. The measurement density parameter may include various numbers of measurement points, which may be increased at or near a dropout location. Thus, for instance, more points may be used in a smaller region for better resolution, which may result in better correlation between the sections. In one example, a higher density of points near the edge of the area 226 at which a portion of the 3D object is being formed may be used to prevent possible dropouts.

As discussed herein, the first surface map 214-1 may have been generated using an initial image parameter to identify the sections 310, 312 of the first image 212-1 and the second image 212-1. The initial image parameter may have included relatively small section 310, 312 sizes of the first image 212-1 and the second image 212-2 with the sections 310, 312 arranged in relatively close spacing with respect to each other as shown in FIG. 3A. The image parameter 216 may differ from the initial image parameter. For instance, the image parameter 216 may define a size that is different from the first size defined in the initial image parameter. In addition, or alternatively, the image parameter 216 may define a spacing between the sections that is different from the spacing defined in the initial image parameter. As a yet further example, the image parameter 216 may define a greater density of comparison points between the sections in the first image 212-1 and the second image 212-2.

The processor 102 may access the image parameter 216 from a set of candidate image parameters 216. For instance, the candidate image parameters 216 may be arranged in a hierarchical list and the processor 102 may access a first image parameter in the hierarchy. However, the processor 102 may also or alternatively access the image parameter randomly. In addition or in other examples, the processor 102 may receive the image parameter 216 from an operator.

According to examples, the processor 102 may apply the image parameter 216 to sections of the first image 212-1 and the second image 212-2 corresponding to or including the dropout 306. Likewise, the processor 102 may apply the image parameter 216 or another image parameter 216 to other sections of the first image 212-1 and the second image 212-2 corresponding to or including a second dropout 308. The processor 102 may further apply the image parameter 216 to the first dropout 306 and the second dropout 308 without applying the image parameter 216 to other sections of the first image 212-1 and the second image 212-2. In this regard, the processor 102 may focalize application of the image parameter 216, which may reduce the amount of processing resource consumption and time in recovering the information at the dropouts 306, 308 as compared with applying the image parameter 216 on sections throughout the first image 212-1 and the second image 212-2 where such recovery may not be needed.

The processor 102 may fetch, decode, and execute the machine-readable instructions 116 to generate a recovered surface map 214-2 using the recovered information. For instance, the processor 102 may combine the first recovered region 320 and the second recovered region 322 to generate a recovered area, which may be incorporated into the recovered surface map 214-2 as shown in FIG. 3C. That is, for instance, as the combination of the first recovered region 320 and the second recovered region 322 may result in recovery of the surface information at the dropout 306, the processor 102 may generate the recovered surface map 214-2 to include the surface information in place of the dropout 306. The processor 102 may combine separate recovered regions to recover the surface information for the second dropout 308.

The processor 102 may fetch, decode, and execute the machine-readable instructions 118 to store the recovered surface map 214-2. The processor 102 may store the recovered surface map 214-2 in a data store (not shown). In some examples, the processor 102 may store the recovered surface map 214-2 based on a determination that the second surface map 214-2 does not include the dropout 306. In other words, a correlation between the first recovered image 320 and the second recovered image 322 may exceed a predefined correlation threshold, and thus, surface measurement data may be read and may be filled into the second surface map 214-2 at the location of the dropout 306.

In some instances, the processor 102 may determine that the application of the image parameter 216 did not result in recovery of the dropout 306. In these instances, the processor 102 may access and apply a different image parameter 216 or a plurality of different image parameters. For instance, the processor 102 may iteratively access and apply different sizes, shapes, orientations, or the like, until the processor 102 determines that the second surface map 214-2 does not include the dropout 306. By way of example, the processor 102 may iteratively access different image parameters and may extract further first recovered regions and further second recovered regions using the different image parameters until the processor 102 generates a recovered surface map that does not include the dropout 306. The processor 102 may also store the surface map that does not include the dropout as the recovered surface map 214-2 of the layer 206.

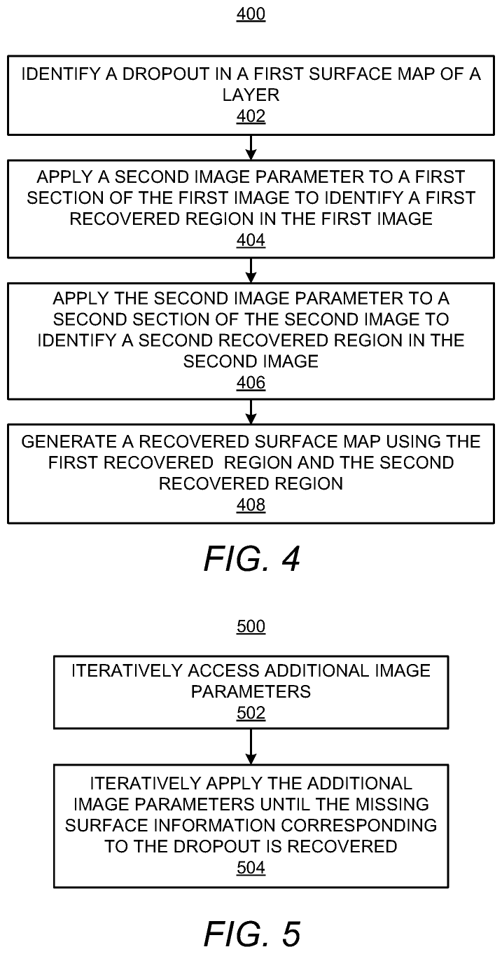

Turning now to FIGS. 4 and 5, there are respectively shown flow diagrams of example methods 400 and 500 for recovering a surface measurement dropout. It should be understood that the methods 400 and 500 depicted in FIGS. 4 and 5 may include additional operations and that some of the operations described therein may be removed and/or modified without departing from the scopes of the methods 400 and 500. The descriptions of the methods 400 and 500 are also made with reference to the features depicted in FIGS. 1-3C for purposes of illustration. Particularly, the processor 102 of the apparatus 100 may execute some or all of the operations included in the methods 400 and 500.

With reference first to FIG. 4, at block 402, the processor 102 may identify a dropout 306 in a first surface map 214-1 of a surface 204. The first surface map 214-1, e.g., of the surface 204 of the layer 206, may be generated using a first image parameter on a first image 212-1 and a second image 212-1 of the layer 206 as discussed herein. In addition, the dropout 306 may correspond to missing surface information, e.g., height information, at a location in in the first surface map 214-1 as also discussed herein.

At block 404, the processor 102 may apply a second image parameter 216 to a first section of the first image 212-1 to identify a first recovered region 320 in the first image 212-1. In addition, at block 406, the processor 102 may apply the second image parameter 216 to a second section of the second image 212-2 to identify a second recovered region 320 in the second image 212-1. The processor 102 may identify the second image parameter 216 from multiple candidate image parameters 216 and the second image parameter 216 may differ from an initial image parameter to identify sections 310, 312 in the first and second images 212-1, 212-2 used to generate the first surface map 214-1. In this regard, the first recovered region 320 may differ from a first section 310 and the second recovered region 322 may differ from a second section 312. The differences may include, for instance, different sizes, different spacings, different orientations, or the like. In this regard, a combination of the first recovered region 320 with the second recovered region 322 may result in the missing surface information being recovered.

According to examples, the processor 102 may apply the second image parameter 216 as part of a search parameter in the first image 212-1 and the second image 212-2. The search parameter may include, for instance, the areas in the first image 212-1 and the second image 212-1 at which the search is to be formed, e.g., the areas at which the dropout 306 corresponds. The processor 102 may apply the search parameter in the first image 212-1 such that a result of a search in the first image 212-1 may result in the first recovered image 320. Likewise, the processor 102 may apply the search parameter in the second image 212-2 such that a result of a search in the second image 212-2 may result in the second recovered image 322.

In effect, application of the search parameter including the second image parameter 216 on the first image 212-1 and the second image 212-2 may yield different results as compared with application the initial search parameter applied to identify the first section 310 and the second section 312. For instance, the different results may include trackable features that may be better compared with respect to each other for a correlation to be made between the trackable features. As a result, for instance, the features in the first and second recovered regions 320, 322 may be tracked more accurately with respect to each other and thus, surface, e.g., height, information at the dropout 306 may be determined from a combination of the first and second recovered regions 320, 322. The processor 102 may execute similar features to determine the surface information for the second dropout 308. In addition, the processor 102 may apply the accessed image parameter 216 locally at locations at which the dropouts 306, 308 are determined to exist instead of applying the accessed image parameter 216 across the entire first image 212-1 or the entire second image 212-2.

At block 406, the processor 102 may generate a recovered surface map 214-2 using the first recovered region 320 and the second recovered region 322. As a combination of the first recovered region 320 and the second recovered region 322 may result in recovery of the surface information missing from the dropout 306, the recovered surface map 214-2 may not include the dropout 306. In this regard, the recovered surface map 214-2 may provide a more comprehensive map of the surface of the layer 206 than the first surface map 214-1.

In some examples, the processor 102 may determine that the recovered surface map 214-2 still includes the dropout 306 or includes another dropout. In these examples, the processor 102 may identify and apply another image parameter 216 on sections of the first image 212-1 and the second image 212-2. Particularly, and as discussed with respect to the method 500 depicted in FIG. 5, the processor 102 may implement an iterative process to generate a recovered surface map that may include a reduced number of dropouts or no dropouts. The operations depicted in FIG. 5 may be implemented in place of blocks 404 and 406 in FIG. 4.

At block 502, the processor 102 may iteratively access additional image parameters 216. In addition, at block 504, the processor 102 may iteratively apply the additional image parameters to a first section of the first image 212-1 and to a second section of the second image 212-2. Thus, for instance, the processor 102 may apply an image parameter 216 to the first section and the second section and determine whether a recovered surface map generated from the results of the image parameter application results in recovery of the dropout 306. In response to a determination that the recovered surface map still includes the dropout 306, the processor 102 may access another image parameter and may determine whether a recovered surface map generated from the results of the image parameter application results in recover the dropout 306. The processor 102 may repeat this process until the processor 102 generates a recovered surface map that does not include the dropout 306. In addition, the processor 102 may identify that recovered surface map as a final recovered surface map of the layer 206. In some examples, the processor 102 may iteratively access the additional image parameters 216 in a predefined order, while in other examples, the processor 102 may randomly access the additional image parameters 216.

In some implementations, the processor 102 may determine recovered surface maps resulting from the application of multiple image parameters and may determine which the recovered surface maps results in the highest level of recovery of the dropout 306. In these implementations, the processor 102 may determine which of the recovered surface maps has the smallest dropout 306, e.g., the least amount of missing information, and may use that surface map as a final recovered surface map for the layer 206.

In the examples discussed above, the processor 102 may generate multiple surface maps 214-1 to 214-N, in which the variable “N” may represent an integer value greater than one. Each of the surface maps 214-1 to 214-N may be a stereoscopic 3D image of the layer 206. In addition, the final surface map 214-N or one of the surface maps 214-2 to 214-N may be the final recovered surface map.

Through implementation of the method 400 and/or the methods 400 and 500, the processor 102 may generate a recovered surface map of the layer in which measurement dropouts appearing on the surface map may have been recovered. The processor 102 may also recover dropouts in a relatively efficient manner while consuming a reduced amount of resources by, for instance, limiting recovery operations to areas of the surface map at which the measurement dropouts appear instead of applying recovery operations across the images from which the surface map is generated.

Some or all of the operations set forth in the methods 400 and 500 may be contained as utilities, programs, or subprograms, in any desired computer accessible medium. In addition, the methods 400 and 500 may be embodied by computer programs, which may exist in a variety of forms. For example, the methods 400 and 500 may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

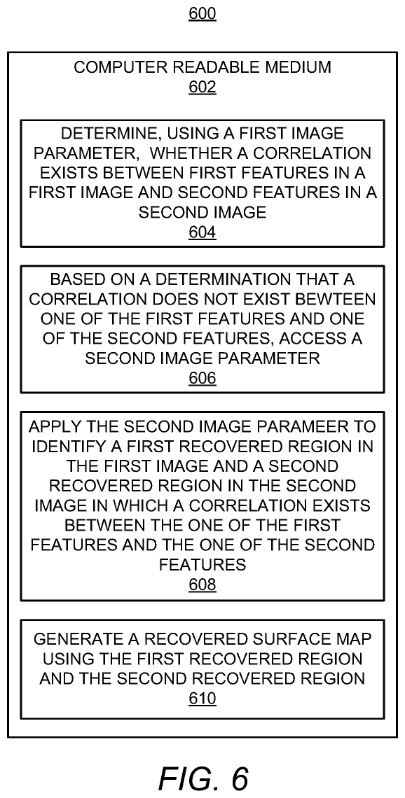

Turning now to FIG. 6, there is shown a block diagram of a non-transitory computer readable medium 602 on which is stored machine readable instructions 604-610 for recovering dropouts in a 3D surface map. A processor 102 may execute the machine readable instructions 604-610. Particularly, the processor 102 may execute the instructions 604 to determine, using a first image parameter, whether a correlation exists between first features in a first image 212-1 and second features in a second image 212-2, the first image 212-1 and the second image 212-2 being combined into a first 3D surface map 214-1. The processor 102 may execute the instructions 606 to, based on a determination that a correlation does not exist between one of the first features and one of the second features, access a second image parameter 216. The processor 102 may execute the instructions 608 to apply the second image parameter 216 to identify a first recovered region 320 in the first image 212-1 and a second recovered region 322 in the second image 212-2 in which a correlation exists between the one of the first features and the one of the second features. The processor 102 may execute the instructions 610 to generate a recovered surface map 214-2 using the first recovered region 320 and the second recovered region 322.

Although not shown, the non-transitory computer readable medium 602 may also include instructions that are to cause the processor 102 to iteratively access additional image parameters 216 and iteratively apply the additional image parameters 216 to a first section of the first image 212-1 and a second section of the second image 212-2 until a correlation is determined to exist between the one of the first features and the one of the second features. In addition, the instructions may cause the processor 102 to determine that a correlation exists based on a correlation exceeding a pre-set correlation threshold value. In addition or alternatively, the instructions may cause the processor 102 to determine that a correlation exists based on a correlation passing pre-set convergence criteria.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents 13 in which all terms are meant in their broadest reasonable sense unless otherwise indicated.

What is claimed is:

1. An apparatus comprising:
a processor;
a memory on which are stored machine readable instructions that when executed by the processor, cause the processor to:
determine whether a first surface map includes a dropout, the first surface map being generated using a first image parameter on a first image and a second image;
based on a determination that the first surface map includes a dropout, recover information corresponding to the dropout;
generate a recovered surface map using the recovered information; and
store the recovered surface map.

2. The apparatus of claim 1, wherein to recover information corresponding to the dropout, the instructions are further to cause the processor to:
access a second image parameter;
apply the second image parameter to a first section of the first image to identify a first recovered region in the first image;
apply the second image parameter to a second section of the second image to identify a second recovered region in the second image; and
generate the recovered surface map using the first recovered region and the second recovered region.

3. The apparatus of claim 2, wherein the instructions are further to cause the processor to:
determine a location on the first surface map at which the dropout is located, wherein the first section of the first image and the second section of the second image includes the determined location on the first surface map.

4. The apparatus according to claim 2, wherein the second image parameter includes at least one of:
a size of the first section and the second section;
a spacing between the first section and the second section;
a spacing between control points where recovery is to be performed within a region containing the dropout of the first image, the second image, or both;
a weighting profile of features in the first section and the second section;
a shape of the first section and the second section;
an orientation of the first section and the second section;
an anisotropy of the features in the first section and the second section; or
a density of measurement points in the first section and the second section.

5. The apparatus of claim 1, wherein to recover information corresponding to the dropout, the instructions are further to cause the processor to:
iteratively access additional image parameters; and
iteratively apply the additional image parameters to a first section of the first image and to a second portion of the second image until the information corresponding to the dropout is recovered.

6. The apparatus of claim 1, wherein the instructions are further to cause the processor to:
determine that the first surface map includes a second dropout at a second location;
recover second information corresponding to the second dropout; and
generate the recovered surface map using the recovered second information.

7. The apparatus of claim 1, wherein the layer comprises a layer of build material particles and wherein the recovered information pertains to height information of the build material particles at a location corresponding to the dropout.

8. The apparatus according to claim 1, wherein the first image and the second image include images of build material particles in the layer that are solidified together and build material particles in the layer that are not solidified to other build material particles.

9. A method comprising:
identifying, by a processor, a dropout in a first surface map of a surface, the first surface map being generated using a first image parameter on a first image and a second image of the surface, and the dropout corresponding to missing surface information;
applying, by the processor, a second image parameter to a first section of the first image to identify a first recovered region in the first image;
applying, by the processor, the second image parameter to a second section of the second image to identify a second recovered region in the second image; and
generating, by the processor, a recovered surface map using the first recovered region and the second recovered region.

10. The method of claim 9, wherein applying the second image parameter further comprises:
iteratively accessing additional image parameters; and
iteratively applying the additional image parameters to the first section of the first image and to the second section of the second image until the missing surface information corresponding to the dropout is recovered.

11. The method of claim 9, wherein, applying the second image parameter to identify the first recovered region and the second recovered region further comprises applying the second image parameter on the first section of the first image and the second section of the second image without applying the second image parameter on other portions of the first image or the second image.

12. The method of claim 9, further comprising:
determining that the first surface map includes a second dropout;
recovering second information corresponding to the second dropout; and
generating the recovered surface map using the recovered information and the recovered second information.

13. A non-transitory computer readable medium on which is stored machine readable instructions that when executed by a processor, cause the processor to:
determine, using a first image parameter, whether a correlation exists between first features in a first image and second features in a second image, the first image and the second image being combined into a first 3D surface map;
based on a determination that a correlation does not exist between one of the first features and one of the second features, access a second image parameter;
apply the second image parameter to identify a first recovered region in the first image and a second recovered region in the second image in which a correlation exists between the one of the first features and the one of the second features; and
generate a recovered surface map using the first recovered region and the second recovered region.

14. The non-transitory computer readable medium of claim 13, wherein to access the second image parameter and to apply the second image parameter, the instructions are further to cause the processor to:
iteratively access additional image parameters; and
iteratively apply the additional image parameters to a first section of the first image and to a second section of the second image until a correlation is determined to exist between the one of the first features and the one of the second features.

15. The non-transitory computer readable medium of claim 13, wherein the instructions are further to cause the processor to:
determine that a correlation exists based on a correlation exceeding a pre-set correlation threshold value, by passing pre-set convergence criteria, or both.
